(19) United States
(12) Patent Application Publication
(10) Pub. No.: US 2012/0167752 A1
(43) Pub. Date: Jul. 5, 2012

(54) BALLISTIC TICKET BOARD

(76) Inventors: Thomas G. Buckner, Gibsonia, PA (US); William E. Rosemeyer, Gibsonia, PA (US)

(21) Appl. No.: 11/955,485

(22) Filed: Dec. 13, 2007

Related U.S. Application Data
(60) Provisional application No. 60/874,827, filed on Dec. 14, 2006.

(51) Int. Cl. F41H 5/08; F41H 5/04; B42F 9/00

(52) U.S. Cl. 89/36.02; 89/36.07; 89/926; 89/903; 89/905; 89/914

(57) ABSTRACT

A ballistic ticket board made typically of transparent armor and possibly opaque armor (but also possibly either entirely transparent armor or entirely opaque armor), serving as a shield to protect a police officer or traffic control officer from gunshot.

### CROSS REFERENCE To RELATED APPLICATION

Reference is made to and priority claimed from U.S. provisional application Ser. No. 60/874,827, filed Dec. 14, 2006.

### FIELD OF THE INVENTION

The present invention pertains to the field of armor. More particularly, the present invention pertains to using armor in a ticket board used by a traffic control officer or a police officer when writing a ticket.

### BACKGROUND OF THE INVENTION

Police and parking control officers face a risk of being shot in the line of duty. In a typical scenario, a police officer will make a routine traffic stop, not realizing that the driver or a passenger is armed and dangerous. The officer will approach the vehicle, ask to see the driver's license, and start talking to the driver. At some point, the officer becomes suspicious, and the driver realizes this. The driver then reaches for a gun, and tries to shoot the officer.

In such a scenario, it is unlikely that the officer would be wearing body armor. Even if the officer might be wearing body armor though, the officer would be at such close range that the driver would tend to shoot at the officer's unprotected head area.

What is therefore needed is a way to help protect the head area of a police officer or traffic control officer when the officer has unknowingly approached a possibly lethal threat with the expectation of merely writing a ticket.

### DISCLOSURE OF INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The invention provides a ballistic ticket board comprising a plate of transparent and/or opaque armor having at least one clip attached to a work surface side of the plate for holding a ticket form on the plate. The board may have two clips, one attached at the top of a lengthwise orientation for holding long tickets, and one attached at the top of a widthwise orientation for holding short tickets. The user may hold the board in either the lengthwise or widthwise orientation according to ticket size. The ticket board optionally includes a handle or a cutout region of a size large enough for serving as a handhold, and/or a license holder embedded or attached to the work surface side of the plate, and/or a calculator.

The plate of armor may comprise a plurality of strike plies separated by, and held together by, sheets of interlayer material. At least some of the strike plies are made of glass, polymethyl methacrylate, or polycarbonate.

The ballistic ticket board may further comprise a spall-liner having a surface serving as the work surface, and the spall-liner may be a polycarbonate and may further be coated with a scratch-resistant coating.

Furthermore, the plate of armor may be offered in a right-handed orientation or a left-handed orientation, wherein in the right-handed orientation the cutout region or handle is located on the left side in relation to the work surface, and in the left-handed orientation the cutout region or handle is located on the right side in relation to the work surface.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a perspective view of a ballistic ticket board in a right-handed orientation according to an embodiment of the invention, made using a plate of transparent armor.

FIG. 2 is a perspective view of a ballistic ticket board in a left-handed orientation according to an embodiment of the invention, made using a plate of transparent armor.

FIG. 3 is a block diagram of a ballistic ticket board according to an embodiment of the invention.

FIG. 4 is a schematic diagram of a cross-section of the plate of armor of FIG. 1.

### DETAILED DESCRIPTION

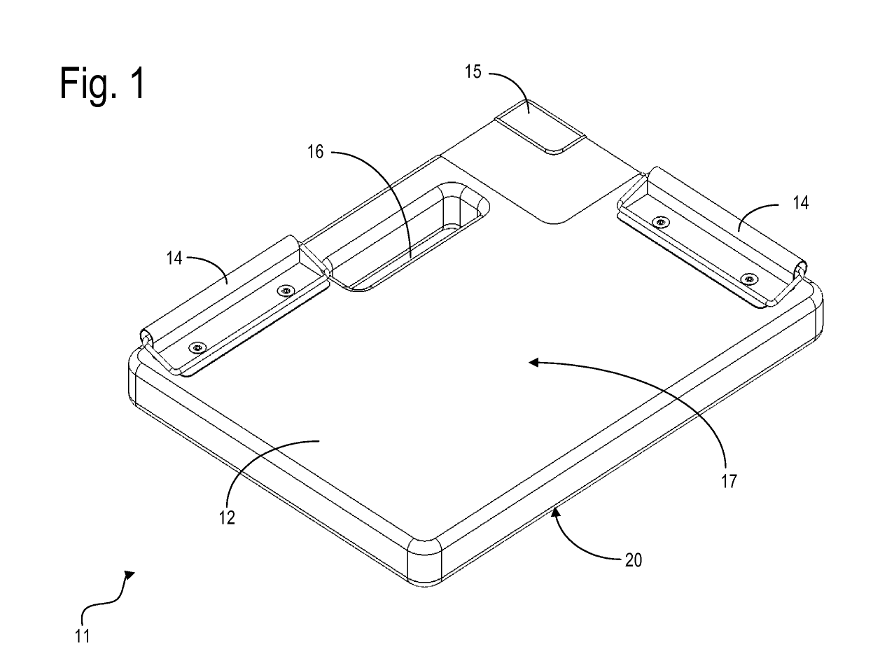

Referring now to FIG. 1, the invention provides a ballistic ticket board 11, for protecting a police officer or traffic control officer after having made a routine traffic stop and then having walked up to the stopped vehicle. FIG. 1 shows a ballistic ticket board 11 in a right-handed orientation. Such a ballistic ticket board is made from a plate 12 of transparent and/or opaque armoring material, having an optional cutout region 16 for use as a handhold, and having at least one clip 14 for holding a ticket form attached to a work surface side 17 of the plate 12, and an optional license holder 15 attached or adhered to the same side of the plate 12 as the clip, or embedded or inscribed in the same side of the plate. The plate may also have attached or adhered to it an electronic calculator (not shown).

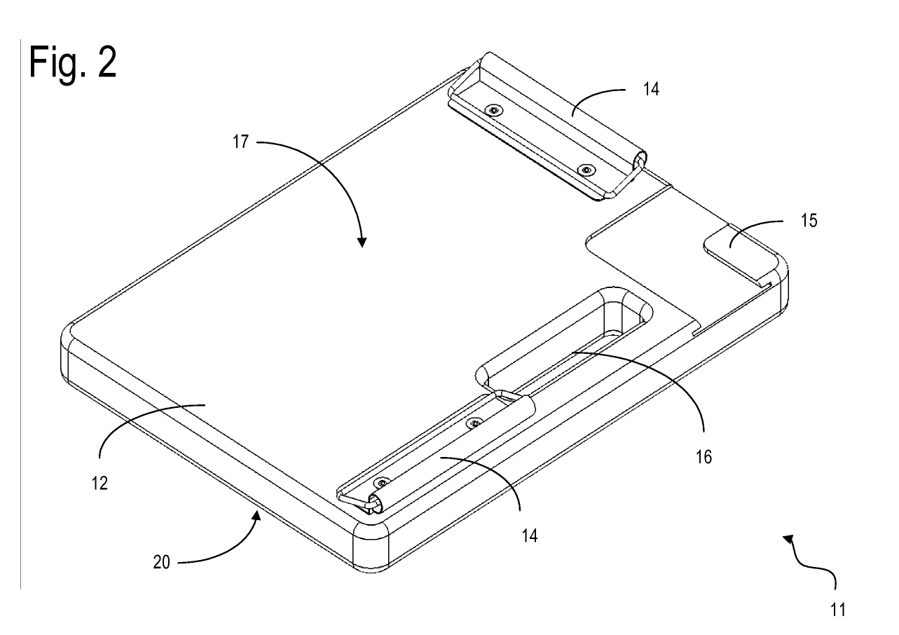

FIG. 2 shows a ballistic ticket board 11 in a left-handed orientation having all the same features presented in FIG. 1 as described above, but in an opposite orientation for a left-handed user.

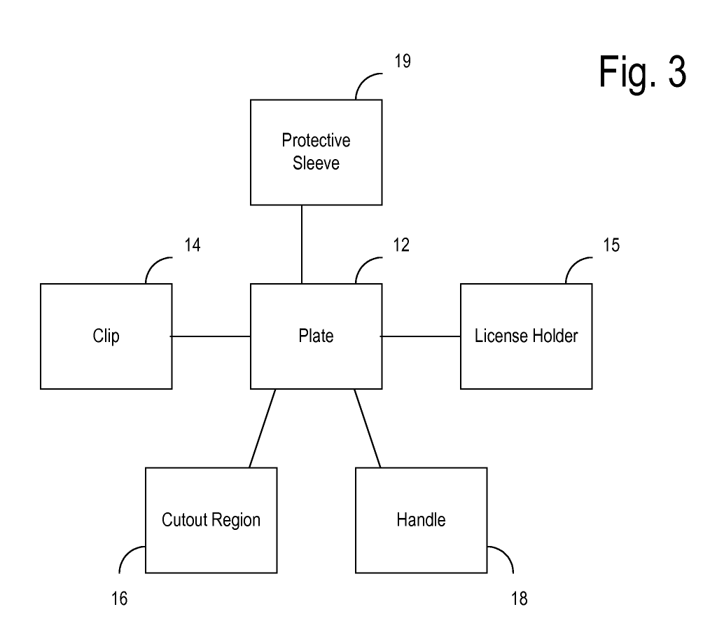

FIG. 3 is a block diagram showing the various options of the ballistic ticket board 11. In either right-handed or left-handed orientations, instead of a cutout region 16 serving as a handhold, the plate 12 could have a handle 18 attached on the target side 20 of the plate opposite the work surface 17, at about the same location as the cutout region 16 in FIG. 1.

Also shown in FIG. 3, to protect the arm the officer uses to hold the ballistic ticket board 11, a protective sleeve 19 of body armor material may be provided attached along its length to the target side 20 of the board that would face the stopped motorist, i.e. the opposite side from the work surface side 17. Such a sleeve could e.g. be made of Kevlar®, available from Dupont, or Spectra Shield®, available from Honeywell, or any other lightweight opaque material suitable for body armor, i.e. at least reasonably flexible.

Kevlar® is made from fibers of long molecular chains produced from poly-paraphenylene terephthalamide. The chains are highly oriented with strong interchain bonding which result in a unique combination of properties.

Spectra Shield® consists of parallel strands of synthetic fiber laid side by side and held in place with a resin system, creating a unidirectional tape. Two layers are then cross-plied at right angles) (0°/90°) and fused into a composite structure under heat and pressure. The pre-consolidated cross-plied material is then packaged as rolls, ready for application as an armoring material. The fiber used in Spectra Shield® is made from ultra-high molecular weight polyethylene created in a gel-spinning process. The gel-spinning process and subsequent drawing steps allow the fiber to have a much higher melting temperature (150° C. or 300° F.) than standard polyethylene.

The officer would typically hold the ballistic ticket board 11 so as to separate the officer's head area from the motorist, with the work surface side 17 facing the officer, and the other side, the target side, facing the motorist. The cut out region 16 is sized and placed so as to allow the officer to pass his or her fingers through the cut out from the target side of the plate to the work surface side 17 of the plate.

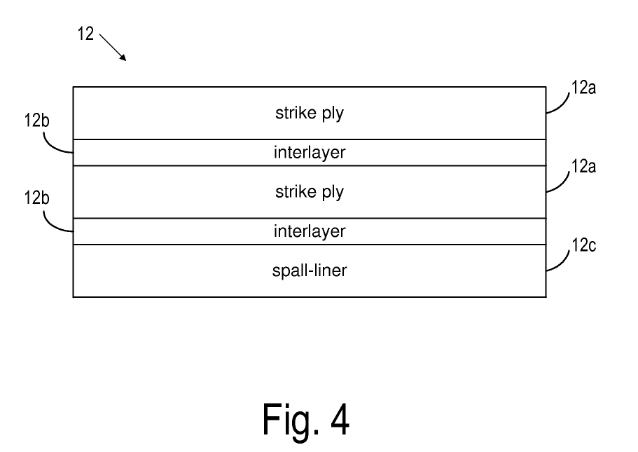

Referring now to FIG. 4, in one embodiment, the plate 12 is made from transparent armor and can be provided using a glass/ceramic/acrylic based laminate, i.e. the plate can be made from several layers of what are called strike plies 12a separated by interlayers 12b of a less brittle material. The strike plies are used to stop the projectile (a round, such as a 0.22 caliber round). Since the strike plies are typically brittle, at least in the case of glass and ceramics, portions of the last strike ply (the last ply from the perspective of the incoming projectile) can become secondary projectiles. To prevent this, the last strike ply may be followed by, or replaced by a spall liner 12c, made from a less brittle material.

For a glass strike ply, a borosilicate (Schott Borofloat™) glass, available from Schott Borofloat of Elmsford, N.Y., can be used. An alternative to a borosilicate glass is soda-lime silica glass or float glass.

For an acrylic strike ply, polymethyl methacrylate (PMMA) can be used, such as so-called cell-cast Plexilgass G® PMMA produced by ATOFINA Chemicals, Inc., of Philadelphia, Pa. (a business of ARKEMA, Inc.).

For a ceramic strike ply, transparent crystalline ceramics such as magnesium aluminate spinel (MgAl₂O₄), aluminum oxynitride spinel (AlON), and single crystal sapphire (Al₂O₃) can be used.

For an interlayer, an aliphatic polyurethane manufactured by Deerfield Urethane, of Whately, Mass., (a business of Bayer Material Science LLC) can be used, such as Deerfield 4700 PU.

For a spall-liner, a polycarbonate can be used, such as Bayer Makrolon AR available from Bayer Sheet Europe, with sales offices in Darmstadt, Germany. The polycarbonate can be coated to improve its scratch resistance.

The thickness of the strike plies and that of the spall liner (which may itself be more than one layer of relatively non-brittle material joined by interlayers) must be adjusted to accommodate the likely threat, taking into account that a weight of more than perhaps three pounds may be too unwieldy to expect routine use.

As another alternative transparent armor embodiment, called here the all-polycarbonate embodiment, the strike plies are themselves polycarbonate. Thus in such an embodiment no glass is used, with the result that the ticket board can be dropped or thrown with less concern for breaking what might otherwise be brittle strike plies. One such alternative embodiment is PowR-Lite® LP 1000-UL LEVEL I, available from Globe Amerada Architectural Glass of Selma, Ala. It provides what is called UL (Underwriters Laboratories) Standard 752 Level I ballistic protection (9 mm full metal copper jacket with lead core, 3 shots in a triangular pattern, 124 grain lead, 15 feet, with no spall and no penetration). It comprises the following laminations: ⅛″ polycarbonate (abrasion resistant), 0.025″ urethane (i.e. an interlayer), ⅜″ polycarbonate, 0.025″ urethane (i.e. an interlayer), ⅜″ polycarbonate, 0.025″ urethane (i.e. an interlayer), ⅛″ polycarbonate (abrasion resistant). Thus, in this arrangement, there is a spall shield on both sides of the plate. The overall nominal thickness is 1″ (1.00″), and having a minimum thickness of 0.948.″ The areal density is approximately 6.16 pounds per square foot.

Using the all-polycarbonate embodiment (so as to provide UL Level I protection), the transparent armor portion (i.e. the plate 12 in FIG. 1) of the ballistic ticket board can be made having 12″×9″×1″ as its nominal dimensions, and having a weight of 4.5 lbs. Other transparent armor options providing the same protection will result in different thickness and weight figures.

The height and width also can be varied from the 12″×9″ figures, and reducing the height and width dimensions is of course extremely helpful in reducing weight. In some embodiments, the ballistic protection may be reduced around the periphery of the ticket board so that the writing surface area remains the same, but the weight of the board is reduced.

In some embodiments, instead of transparent armor, all or a portion of the ticket board plate 12 (FIG. 1) can be made from opaque armor. This has a weight advantage, but can make it harder for the traffic control officer or police officer to observe the behavior of a motorist. Observing the behavior of the motorist can be helpful in anticipating an attack by the motorist.

In embodiments where an opaque armor is used in whole or in part, there are many possibilities. The choice of armor depends on the desired level of protection, the acceptable weight of the ticket board, the acceptable level of bulkiness of the ticket board plate, and cost. A reasonable choice is Kevlar® or Spectra Shield®, both mentioned above, or some other body armor material. Such opaque armors have the merit of being durable (i.e. are not brittle) and have a low areal density.

As one skilled in the art would know, there is a good assortment of opaque armoring materials like Kevlar® or Spectra Shield® under development. The most readily available alternative fiber is called Vectran, which is approximately twice as strong as Kevlar, and 5 to 10 times stronger than steel. It is a manufactured fiber, spun from a liquid crystal polymer created by Celanese Acetate LLC. Chemically it is an aromatic polyester.

Another candidate under development is carbon nanotubes. Carbon nanotube thread is still rare, and fabric is even rarer. Price is the major impediment to using carbon nanotubes for body armor today. Carbon nanotubes are an allotrope of carbon; they are carbon molecules in a cylindrical shape and have novel properties that make them potentially useful in a wide variety of applications. Inorganic nanotubes have also been synthesized. Nanotubes are members of the fullerene structural family, which also includes buckyballs, but where buckyballs are spherical in shape, a nanotube is cylindrical.

In some embodiments, both opaque armor and transparent armor can be used, with the opaque armor forming the outer peripheral portions of the plate 12 (FIG. 1), so that the traffic control officer or police officer is still able to look through a transparent center portion, but because the outer portion is opaque, the plate weighs less than for an all-transparent plate providing the same protection. In such embodiments, instead of a cutout region, a handle can be attached to the outer opaque portion.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A ballistic ticket board, comprising:
a plate of armor; and
at least one clip attached to a work surface side of the plate for holding a ticket form on the plate.

2. The ballistic ticket board as in claim 1, further comprising a license holder embedded or attached to the work surface side of the plate of armor, for holding a license.

3. The ballistic ticket board as in claim 2, wherein the license holder is provided as an indented region on the work surface side of the plate of armor.

4. The ballistic ticket board as in claim 1, wherein the plate comprises a plurality of strike plies separated by and held together by sheets of interlayer material.

5. The ballistic ticket board as in claim 4, wherein at least some of the strike plies are glass.

6. The ballistic ticket board as in claim 4, wherein at least some of the strike plies are polymethyl methacrylate.

7. The ballistic ticket board as in claim 4, wherein at least some of the strike plies are polycarbonate.

8. The ballistic ticket board as in claim 4, further comprising a spall-liner having a surface serving as the work surface.

9. The ballistic ticket board as in claim 8, wherein the spall-liner is a polycarbonate.

10. The ballistic ticket board as in claim 8, wherein the polycarbonate is coated with a scratch-resistant coating on the work surface side.

11. The ballistic ticket board as in claim 1, wherein the plate has a cutout region for serving as a handhold.

12. The ballistic ticket board as in claim 1, wherein the plate has a handle attached to a side of the plate opposite the work surface.

13. The ballistic ticket board as in claim 1, further comprising a sleeve made from body armor material attached along the length of the sleeve to the side of the plate opposite the work surface.

14. The ballistic ticket board as in claim 13, wherein the sleeve is made from Kevlar®.

15. The ballistic ticket board as in claim 13, wherein the sleeve is made from Spectra Shield®.

16. The ballistic ticket board as in claim 1, wherein the plate is made at least in part from transparent armor.

17. The ballistic ticket board as in claim 1, wherein the plate is made at least in part from opaque armor.

18. The ballistic ticket board as in claim 1, wherein the plate has a central portion made from transparent armor and an outer periphery made from opaque armor.

19. The ballistic ticket board as in claim 1, wherein the board is manufactured in either a right-handed orientation or a left-handed orientation.
